(19) United States
(12) Patent Application Publication
(10) Pub. No.: US 2003/0115909 A1
(43) Pub. Date: Jun. 26, 2003

(54) Plasma chemical vapor deposition methods and apparatus

(76) Inventors: Keith L. House, Corning, NY (US); Samir Khanna, Painted Post, NY (US); Barton G. Lane III, Belmont, MA (US); Prantik Mazumder, Corning, NY (US)

Correspondence Address: CORNING INCORPORATED, SP-TI-3-1, CORNING, NY, 14831

(21) Appl. No.: 10/027,282

(22) Filed: Dec. 21, 2001

(51) Int. Cl. C03B 37/018

(52) U.S. Cl. 65/391; 65/418; 65/530

(57) ABSTRACT

The invention relates to the field of PCVD methods of making an optical fiber and apparatuses for use in PCVD methods. The disclosed methods and apparatuses improve the PCVD process by enhancing the efficiency of the deposition process. The use of the disclosed methods and apparatuses, individually or in combination thereof, will result in at least reducing the time necessary to deposit a predetermined amount of glass on a substrate.

### FIELD OF THE INVENTION

The invention relates to the field of manufacturing optical fibers and more particularly to inner vapor deposition processes for manufacturing an optical fiber.

### BACKGROUND OF THE INVENTION

Optical fibers have acquired an increasingly important role in the field of communications, frequently replacing existing copper wires. This trend has had a significant impact in the local area networks (i.e., for fiber-to-home uses), which has seen a vast increase in the usage of optical fibers. Further increases in the use of optical fibers in local loop telephone and cable TV service are expected, as local fiber networks are established to deliver ever greater volumes of information in the form of data, audio, and video signals to residential and commercial users. In addition, use of optical fibers in home and commercial business environments for internal data, voice, and video communications has begun and is expected to increase.

Optical fibers typically contain a glass core, a glass cladding, and at least two coatings, e.g., a primary (or inner) coating and a secondary (or outer) coating. The primary coating is applied directly to the glass fiber and, when cured, forms a soft, elastic, and compliant material, which encapsulates the glass fiber. The primary coating serves as a buffer to cushion and protect the glass fiber core when the fiber is bent, cabled, or spooled. The secondary coating is applied over the primary coating and functions as a tough, protective outer layer that prevents damage to the glass fiber during processing and use.

The glass fiber is drawn from an optical fiber preform. The preform may be formed by one of various chemical vapor deposition processes, one such processes is plasma chemical vapor deposition (PCVD). In the PCVD process, a stream of reactant gases is fed into a cylindrical tube and the reaction of the reactants is promoted by a traversing microwave plasma. The plasma is created by a microwave applicator that directs microwaves through the walls of the tube and ionizes at least one gas inside the tube. The plasma activates the dissociation-reaction of the reactants and leads to the deposition of thin layers of silica glass on an inner surface of the tube. The aforementioned PCVD process is a low pressure process. During the PCVD process, the tube may be rotated and the tube is maintained in a furnace at a temperature of about 1000 to 1300° C. Once a desired amount of glass is deposited on the inside of the tube, the tube is collapsed into a cane. Optionally, prior to finishing the collapse, a centerline of the tube may be etched.

A shortcoming of the aforementioned PCVD process is the low deposition rate of the glass. Past attempts to increase the deposition rate have included increasing the mass flow rate of reactant gases into the tube, however, this attempt increases the pressure in the tube to exceed the soot formation pressure. Operating the deposition above the soot formation pressure leads to the formation and deposition of soot particles instead of glass.

An additional limitation of the deposition of glass is that the deposition is limited by diffasional transport of the glass material from the plasma to the inside wall of the tube. Increasing the mass flow rate of reactants into the tube, can lead to the reactant gases passing through the plasma zone prior to the reactants reacting. This results in at least material loss, downstream production of soot particles instead of direct deposition of glass, and/or non-uniform radial profiles along an axial distance of the tube. A need exists to increase the deposition rate of glass in the PCVD process.

Another shortcoming of the aforementioned PCVD process is that a preform formed by the aforementioned method may exhibit a exponentially decaying thickness profile of deposited glass near the tailstock end of the preform. The tailstock end is the end of the preform which unreacted reactant gases and undeposited matter exit the tube, also known as the end of the tube opposed to the end of the tube which the reactants enter the tube. Matter that is being deposited along the tailstock end has a tendency to be soot particles due to sudden change in the thermal condition. Also, not all of the soot particles that are formed may be deposited onto the tube. Some of the soot particles may be drawn into the vacuum pump attached to the tailstock end of the preform. The presence of soot particles in the pump negatively impacts the life and performance of the pump. Therefore, a need exists to prevent soot particles from entering the vacuum pump. Furthermore, a need exists to eliminate the formation of soot particles and the migration of such soot particles into the vacuum pump.

### SUMMARY OF THE INVENTION

One aspect of the present invention relates to methods and apparatuses that will improve the efficiency of the deposition process. These methods and apparatuses will reduce the time period necessary to deposit glass on a substrate. A first method includes a method of making an optical fiber preform assembly. The method includes the step of forming a plasma inside a tube, thereby forming a plasma zone. The method also includes introducing a flow of precursor suitable for forming glass into the plasma zone, wherein said flow comprises eddy diffusion of the flow of the precursor.

Another method that may be practiced to increase deposition efficiency includes a method of making an optical fiber preform assembly. The method includes the step of forming a plasma inside a tube, thereby forming a plasma zone. The method also includes the step of introducing a flow of at least one precursor suitable for forming glass into the plasma zone. Lastly, the method includes the step of creating eddy diffusion flow of matter in the plasma zone.

A further method that may be practiced to enhance deposition efficiency includes a method of depositing glass on a substrate. The method includes the step of flowing at least one glass precursor material at a predetermined mass flow rate into a substrate. The predetermined mass flow rate comprises a rate at which the pressure within the substrate comprises no more than about 99% of the soot formation pressure. The method may also include the step of reacting the glass precursor inside the substrate; and subsequently modulating the mass flow rate to maintain the pressure within the substrate substantially constant.

An additional method that will result in improving the deposition efficiency includes a method of depositing glass on a substrate. The method includes the step of depositing glass on an internal surface of a substrate having first and second ends and the additional step of inserting a rod inside said second end of the of the substrate. The length of the portion of the rod inserted into the substrate comprises less than the entire length of the substrate.

An advantage that will result from practicing the above methods is the enhancement of transport rates of the glass from the plasma to the substrate. Another advantage that will result from practicing either one of the above methods includes reducing the deposition zone. An additional advantage that will result from at least practicing the additional method above includes reducing the decay length at the tailstock end. This will result in less precursors being lost as soot drawn into the effluent and at least minimizing, if not eliminating, remediation of the vacuum pump due to damage caused by soot particles drawn into the pump.

An apparatus, which may be used to improve deposition efficiency, is a microwave applicator for forming a plasma for a chemical vapor deposition process. The inventive applicator includes a housing and a surface adjacent to an outer surface of a substrate. The surface comprises at least one portion protruding toward said outer surface of the substrate.

The protruding portion causes changes to the microwave field. The changes give rise to radial and/or azimuthal flow in the gas stream and enhance the transport of glass precursor material to the walls of the tube, and likewise enhance the deposition rate. Furthermore any of the above methods or apparatuses may be incorporated into the PCVD process to maximize the deposition rate of glass onto the substrate.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention, and together with the description serve to explain the principles and operation of the invention.

### BRIEF DESCRIPTION OF THE DRAWINGS

FIG. 1 is a block schematic side view of a PCVD lathe in accordance with the invention.

FIG. 2 is a schematic view of the substrate and microwave applicator in accordance with the invention.

FIG. 3 is front face view of an eddy current element inside a substrate.

FIG. 4 is a side cross sectional view of an eddy current element inside a substrate.

FIG. 5 is a side cross sectional view of a microwave applicator in accordance with the invention.

FIG. 6 is an end cross sectional view of a substrate and a portion of the inventive microwave applicator in accordance with the invention.

FIGS. 7-9 are graphs of the flow rate of the precursor material into the substrate.

FIG. 10 is a graph of the deposition rate as a function of time.

FIG. 11 is a cross sectional view of a substrate and a rod in accordance with the invention.

FIG. 12 is a graph of the phase diagram of pure silica within the pressure range of 10-100 Torr.

### DESCRIPTION OF THE INVENTION

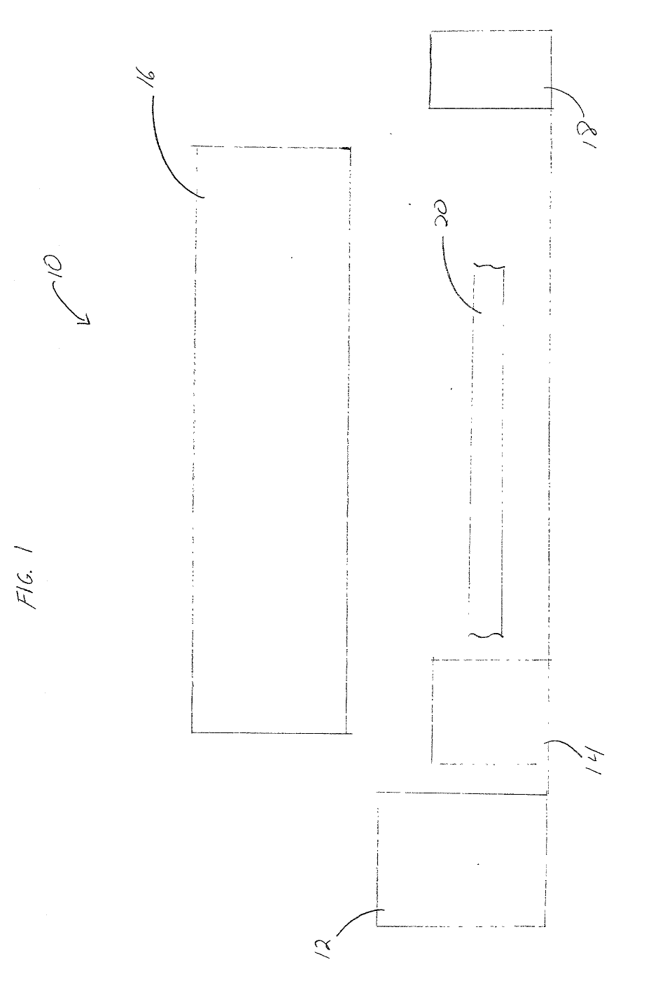

Reference will now be made in detail to the present preferred embodiments of the invention, an example of which is illustrated in the accompanying drawings. Wherever possible, the same reference numbers will be used throughout the drawings to refer to the same or like parts. An exemplary embodiment of a PCVD is shown in FIG. 1, and is designated generally throughout by reference numeral 10.

PCVD lathe 10 is represented in FIG. 1. The lathe includes a headstock end 12, a microwave applicator 14, a furnace 16, and a tailstock end 18. Also shown in FIG. 1 is a partial view of substrate 20. Preferably lathe 10 is a low-pressure process, which operates at about 20 torr or less, more preferably about 15 torr or less, and most preferably about 12 torr or less, the aforementioned pressure is the pressure within substrate 20, and preferably the temperature of substrate 20 is about 1500° C. or less. First, a substrate 20 is loaded into lathe 10. Substrate 20 preferably comprises a glass tube, more preferably a fused silica glass tube. Substrate 20 typically has an annulus of at least 1 mm thick. Examples of preferable substrate sizes include a tube with an ID of about 21 mm and an OD of about 25 mm or a tube with an ID of about 26 mm and an OD of about 31 mm. Typically, the tube is about 50 cm long or about 100 cm long.

Preferably furnace 16 is movable such that furnace 16 may encompass substrate 20 and heat substrate 20 to a temperature of about 2000° C. or less, more preferably about 1500° C. or less, even more preferably about 1300° C. or less, and most preferably about 1250° C. or less. Preferably, the temperature of substrate 20 reaches a substantially isothermal condition. Isothermal is used herein to mean at least the substrate does not have a thermal gradient that is more than about 10° C. over a distance of 1 mm, preferably the thermal gradient is not more than about 5° C. over a distance of 1 mm. The thermal gradient can be either in the axial or radial direction of substrate 20. Optionally, substrate 20 may be rotated during the heating step. Optionally, the rotating of substrate 20 may continue throughout the PCVD process. Furnace 16 may be aligned with substrate 20 such that only a portion of substrate 20 is heated by furnace 16. Preferably, furnace 16 heats at least an interior portion of substrate 20. One source of furnace 16 is Mellen.

In one embodiment of the invention, once substrate 20 reaches an isothermal condition, a gas capable of forming a plasma is flown into an internal passage of substrate 20. However, substrate 20 is not required to be heated prior to flowing of the plasma forming gas into substrate 20. An example of a gas capable of forming a plasma is O₂, however, the invention is not limited to O₂ as the plasma forming gas. A non-exhaustive list of plasma forming gases comprises O₂, N₂, He, Ar, and combinations thereof.

Along with the flow of the plasma forming gas, the precursor material is also flown into the internal passage of substrate 20. Headstock 12 includes a manifold (not shown) for charging the precursors and the plasma forming gas into substrate 20. Suitable precursors include any precursors suitable for forming glass, preferably silica based glass. The glass may be doped or un-dpoed. A non-exhaustive list of precursors includes non-hydrogen containing silicon containing compounds such as SiCl₄, SiBr₄, SiL₄, SiFCl₃, and mixtures thereof. Other potential precursors include C₈H₂₄O₄Si₄, O₂, GeCl₄, GeBr₄, GeI₄, CF₄, and, C₂F₆ and combinations thereof. A non-exhaustive list of potential dopants includes Ge, P, Al, Sb, Ta, F, B, Ga, In, Sb, Er, Li, Na, K, Rb, Cs, Be, Mg, Ca, Sr, Ba, Ti, Se, Te, Fr, Ra, Bi, or mixtures thereof. The plasma forming gas may also be one of the precursors.

In one embodiment of the invention the precursor gases of SiCl₄ and O₂ are directed down the center of substrate 20. The flow rate of SiCl₄ is about 1.42 to about 14.2 g/min or more. A preferred flowrate of SiCl₄ is at least about 5.7 g/min, more preferably at least about 7.1 g/min, and most preferably at least about 8.5 g/min. O₂ is introduced into the tube in terms of a ratio (O₂:SiCl₄) to SiCl₄, the ratio ranges from about 2:1 to about 6:1, preferably about 4:1. Headstock 12 has the capabilities to regulate and monitor the flow of the precursors and any plasma forming gas into substrate 20. Potential dopants that could be included in the silica include germanium and/or fluorine. In the above embodiment preferably silica glass is deposited on substrate 20 at a rate of about 0.5 g/min to about 5.0 g/min.

The gases (precursors and the plasma forming gas) should not be charged into substrate 20 such that the pressure inside substrate 20 is at or exceeds the soot formation pressure. The “soot formation pressure (P_{SF})” is the pressure above which, for a given multi-component system, at a given temperature, the reaction of the glass precursors will result in the formation of soot particles instead of the direct deposition of glass onto an internal wall of substrate 20. If the pressure inside substrate 20 exceeds the soot formation pressure, the transformation reaction of precursor into the direct deposition of glass onto the internal wall of substrate 20 is inhibited. At pressures above the P_{SF}, typically the precursor material is transformed into a soot particle and not directly deposited onto substrate 20 as glass. Soot is defined as at least sub-micron sized solid or liquid particles formed out of the gas phase, typically the soot is unconsolidated glass.

In apparatus 10, microwave energy is used to create the plasma in substrate 20 and in turn start the reaction to form the glass. In apparatus 10, applicator 14 traverses along substrate 20 and applicator 14 emits microwave beams. The microwave beams ionize the gas capable of forming the plasma to form the plasma. The power of the microwave system ranges from about 2 to about 5 kilowatts. Applicator 14 may include an internal chamber referred to as an activator chamber. One source of applicator 14 is Aztex.

The deposited glass is fully dense glass, preferably silica based glass. Preferably, all precursors are reacted and no glass soot particles are formed. It is preferred that any unreacted precursors or precursors which form soot instead of glass are exhausted from substrate 20 through tailstock end 18. Preferably, tailstock end 18 includes a vacuum pump (not shown).

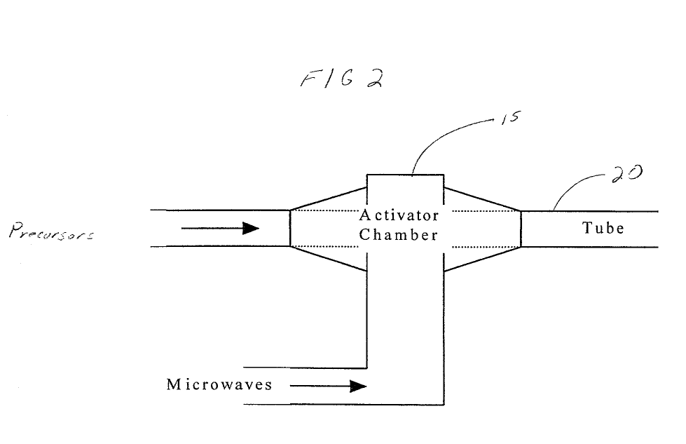

The relationship between applicator 14 and substrate 20 is illustrated in FIG. 2. As shown, an activator chamber 15 of applicator 14 encircles substrate 20. Microwave beams generated in apparatus 10 travel along an internal chamber of applicator 14 to chamber 15. The microwave beams ionize a gas traveling along an internal passage of substrate 20 creating the plasma. The plasma creates an environment, which causes the precursors to react and form gaseous SiO. The SiO diffuses toward an internal wall of substrate 20 and heterogeneously reacts with oxygen preferably at the internal wall and results in the direct deposition of SiO₂ onto the internal wall of substrate 20. Preferably the temperature of the plasma is at least about 1725° C., more preferably at least about 2000° C., even more preferably at least about 2100° C. It is further preferred that the temperature of the plasma is not more than about 3000° C., more preferably not more than about 2725° C.

In one embodiment of the invention, the gas that forms the plasma comprises oxygen and the precursors that form the glass comprise oxygen and a silicon-containing compound, e.g. SiCl₄. The aforementioned deposition process is continued until a predetermined amount of glass is deposited on substrate 20.

Once the deposition of glass is completed, the substrate may be collapsed into a rod or a cane. A hydrogen-oxygen burner may be used to collapse substrate 20 into a cane. The burner traverses along an outer surface of substrate 20 in the length direction of substrate, as substrate 20 is rotating. While the burner is traversing, optionally a positive pressure is applied to the inside of substrate 20. Typically, substrate 20 will collapse in about 4 to 10 passes of the burner. Preferably, the substrate collapses in about 4 passes of the burner.

In one embodiment of the invention, once the tube has been collapsed into a cane, additional soot can be deposited onto preferably an exterior surface of the cane. The soot may be deposited by any chemical vapor deposition technique such as OVD or VAD. The soot coated cane may then be sintered and drawn into an optical fiber. The use of plasma chemical vapor deposition allows for the production of complex core profiles in a one step core deposition process. Alternative, the cane may be drawn directly into a fiber without additional soot being deposited onto the cane.

For additional information regarding PCVD the following U.S. patents and patent applications are incorporated herein their entirety: U.S. Pat. Nos. 5,397,395, U.S. Pat. Nos. 5,443,645, U.S. Pat. Nos. 5,443,648, U.S. Pat. Nos. 5,439,715, U.S. Pat. Nos. 5,510,151, and WO 99/35304.

One aspect of the invention relates to techniques to improve the rate of the deposition of the glass onto substrate 20, preferably an internal surface of substrate 20. The technique includes a method of making an optical fiber preform assembly. The method includes forming a plasma inside substrate 20, such as a tube, thereby forming a plasma zone; and introducing a flow of precursor suitable for forming glass into the plasma zone. The flow comprises eddy diffusion of the flow of the precursor. Eddy diffusion is used herein to mean at least the following:

the flow of matter through substrate 20 that is not completely along a straight or horizontal path through substrate 20. More preferably, eddy diffusive flow includes the existence of circulating cells of matter in the flow path inside of substrate 20. The cells of matter introduce a radial flow to the flow of matter inside substrate 20.

The above method includes the advantage of creating a flow path that directs the matter in substrate 20 away from a center of substrate 20 and closer to an internal surface of substrate 20.

Another method that may be used to improve the rate of the deposition of the glass onto substrate 20, preferably an internal surface of substrate 20, includes a method of making an optical fiber preform assembly. The method includes the steps of: (1) forming a plasma zone inside a tube, thereby forming a plasma zone; (2) introducing a flow of at least one precursor suitable for forming glass into the plasma zone; and (3) creating eddy diffusion of the precursor flow in the plasma zone. The step of creating may comprise forming a gradient in the concentration in the plasma zone in the axial direction of substrate 20. Preferably, the Reynolds number of the gases flowing down substrate 20 comprises at least about 20 or more.

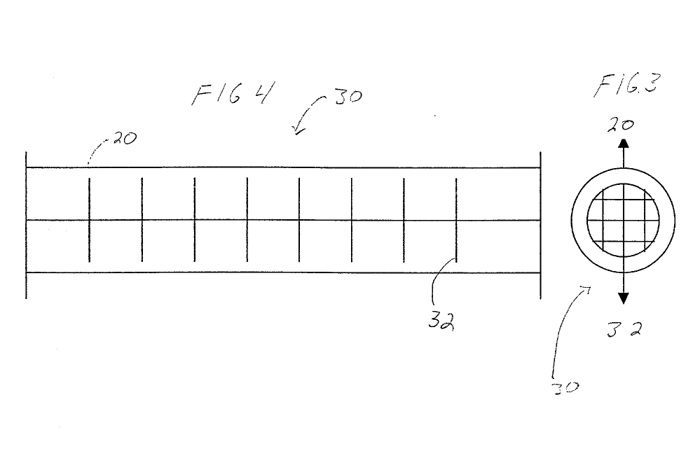

The step of creating eddy diffusion may comprise inserting an eddy element inside said tube. An example of one type of eddy element is illustrated in FIGS. 3 and 4, generally designated 30. FIG. 3 is a front view of substrate 20 with an eddy element 32. Preferably element 32 comprises a structure or means that will interrupt the flow pattern of the gases or particles traveling along substrate 20. Eddy element 32 shown is in the form of a mesh structure. Eddy element 32 is not limited to any particular design of eddy element 32. However, it is preferred that eddy element 32 directs matter away from an axial center line of substrate 20. It is also preferred that eddy element 32 has a length at least equal to a segment of substrate 20, more preferably the length of element 32 is almost about the same as the length of substrate 20.

Preferably the method further comprises aligning element 32 along an axial centerline of substrate 20, thereby preventing said precursor from flowing along a center axis of the tube from a first end of substrate 20 to a second end of substrate 20. Optionally the length of eddy element 32 comprises substantially the same length as the useable length of substrate 20. “Useable length” is herein defined as at least a portion of substrate 20 in which the glass deposited on substrate 20 has a uniform thickness and optionally that segment along substrate 20 in which the amount of dopant deposited is controllable. In one embodiment, the useable length of substrate 20 is the length of substrate 20 that is encompassed by furnace 16 minus any the portion of substrate 20 encompassed by furnace 16 that has exhibited exit and entrance effects. One typical useable length for substrate 20 in lathe 10 is about 0.8 m.

A further method that may used to practice this aspect of the invention includes a method of making an optical fiber preform assembly. The steps of the method include the steps of: (1) inserting an eddy current element into substrate 20; (2) forming a plasma zone inside a tube, thereby forming a plasma zone; and (3) introducing a flow of at least one precursor suitable for forming glass into the plasma zone.

In another embodiment of the invention, creating eddy diffusion may comprise pulsing an energy source to form the plasma. This embodiment of the invention may include charging the microwaves to the activator chamber on an periodic or non-periodic basis. In an second alternate embodiment of the method, creating the eddy diffusion comprises churning the precursors. Churning comprises at least mixing the precursor material prior to the precursor material reacting. Preferably the creating comprises imparting a spiral spin into the plasma.

The method may also include the optional step of depositing glass on an inner surface of the tube at a deposition rate of greater than about 1.5 grams/minute. Preferably the deposition rate comprises at least about 2.5 grams/per minute. More preferably the deposition step does not include depositing soot particles on an inner surface of said tube. Another optional step comprises ceasing the step of depositing prior to an inner radius of said tube after said depositing being less than about 10% of an inner radius of said tube prior to said depositing.

An advantage of the above method includes shortening the deposition zone. The above methods may be used to shorten the deposition to less than about 18% of the length of the substrate 20, preferably less than about 15% of the length, and more preferably less that about 10% of the length, and most preferably less than about 8% of the length.

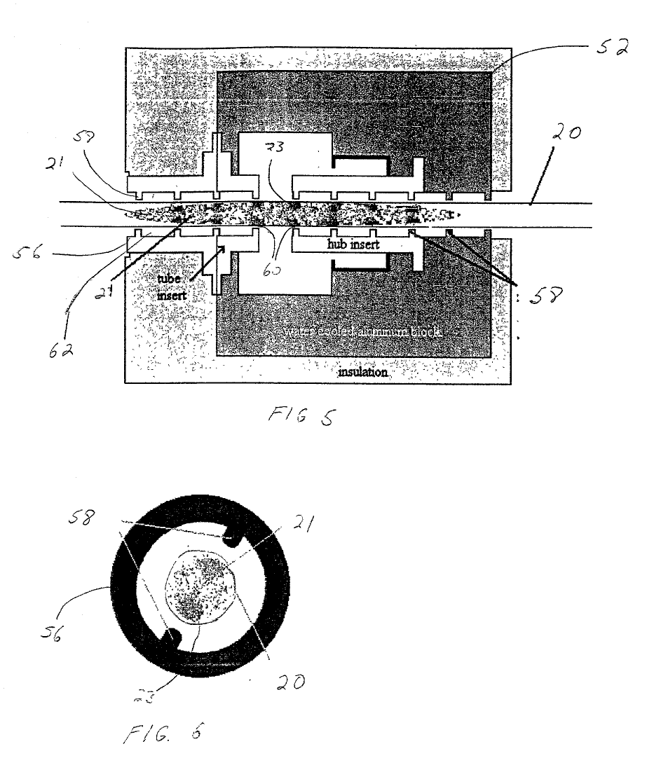

The invention further includes improving the rate of the deposition of glass onto substrate 20, preferably an internal surface of substrate 20, by imparting a radial motion in the flow of matter inside substrate 20, e.g. radial flow of the precursor material. An inventive microwave applicator for forming a plasma for a chemical vapor deposition process is an apparatus which may be used to impart the radial motion, shown in FIG. 5, generally designated 50. The inventive applicator 52 includes a housing 54 and at least one surface 56 adjacent an outer surface of substrate 20. The surface 56 comprises at least one portion 58 protruding toward the outer surface of the substrate 20. As shown in FIG. 5, a gap 60 may exist between portion 58 and the outer surface of substrate 20. Preferably gap 60 is equal to or less than about ⅗ of gap 62 between non-protruding surface portion 64 of surface 56 and the outer surface of substrate 20, more preferably gap 60 comprises equal to or less than about ½ of gap 62 between the outer surface of substrate 20 and non-protruding portion 64. The minimum distance would be where protruding portion 58 actually touches the outside of substrate 20. Optionally portion 58 can be physically oscillated within applicator 52. Typically the length of portion 58 is on the same order of magnitude as the internal diameter of the substrate 20. A typical range of lengths for portion 58 comprises about one-half to about two times the internal diameter of substrate 20. Protruding portion 58 is not limited to anyone configuration. Protruding portion 58 may comprise at least one helical rib that extends along at least a segment of surface 56 of applicator 52, more preferably at least two helical ribs. Preferably the segment comprises at least a majority of surface 56. Preferably the segment comprises at least about 10 cm or more. More preferably, portion 58 extends along substantially all of surface 56.

Alternatively portion 58 may comprise a plurality of baffles staggered along at least a segment of surface 56. The baffles may be staggered uniformly or non-uniformly along the segment. The same limitations regarding the segment and the ribs apply to the segment and the baffles. In a third embodiment, portion 58 may comprise a conductive heat element or an element capable of forming a thermal gradient along the outer surface of substrate 20. Any of the above embodiments of portion 58 may be used in combinations with one another. The length of portion 58 may be uniform or random in any particular embodiment. Likewise, the length of gap 60 may be uniform or random.

Portion 58 creates a spiral flow in plasma zone 21 in substrate 20. Darker areas 23 of FIGS. 5 and 6 indicate more intense areas of plasma in plasma zone 21. FIG. 6 is an end view of surface 56 and plasma filled substrate 20. Preferably, the plasma is intensified in the vicinity of portions 58.

Preferably an applicator with at least one surface 56 will impart an azimuthal or spiral spin on the plasma, reactants, glass, or any combination thereof. Use of the inventive applicator in the PCVD will result in the advantage of creating localized azimuthal eddies in the flow of matter in substrate 20. Another advantage, which will result from practicing the invention, is that the glass will be deposited in a highly symmetric pattern. The invention has a particularly useful application in processes, which include a non-axissymmetrical feed of matter; e.g. precursors or microwave beams. This is for the reason that the invention produces a very localized non-axissymetric discharge, which averages a highly symmetric discharge. This invention may also be used to deposit glass onto substrates with an internal diameter of as little as about 0.1 cm to about 15 cm.

The invention further includes another method for increasing the rate of the deposition of the glass onto substrate 20. The method includes flowing a glass precursor material at a predetermined mass flow rate into substrate 20. The predetermined mass flow rate comprises a rate at which the pressure within substrate 20 comprises no more than about 99% of the soot formation pressure. Preferably the pressure in the substrate comprises no more than about 95% of the soot formation pressure, more preferably no more than about 90%, and most preferably no more than about 85%. For example, if the soot formation pressure is about 20 torr, the pressure in substrate comprises no more than about 19.8 torr, preferably no more than about 19 torr, more preferably no more than about 18 torr, and most preferably no more than about 17 torr.

The method further includes reacting the glass precursor inside substrate 20 and subsequently modulating the mass flow rate to maintain the pressure within substrate 20 substantially constant. Optionally, the step of modulating the mass flowrate may comprise a stepwise modulation of the mass flow rate, a continuous modulation of the mass flow rate, or combinations thereof. Preferably, the modulating comprises reducing the mass flow rate of the glass precursor material. Preferably the glass precursor material comprises at least one silicon containing compound, preferably a non-hydrogen containing silicon containing compound, e.g. SiCl₄, SiBr₄, Sil₄ and combinations thereof.

Preferably the reacting step comprises forming a plasma inside substrate 20. Optionally, the method may include the step of maintaining an intensity of the plasma substantially constant during the depositing. Substantially constant is meant to mean that the intensity of the plasma does not vary by more than about 15%, more preferably not more than about 10%, and most preferably not more than about 5%. Conversely, the method may include the step of reducing the intensity of the plasma during the deposition process. The reduction of the intensity of the plasma may be stepwise or continuous. Preferably an initial deposition rate during the deposition process comprises

m₁=R_{I}⁴(P_{SF}²−P_{T}²)/(C₁Tμ_{eff}(1+x))

wherein mᵢ comprises an initial deposition rate, R_{I} comprises initial internal radius of the substrate, P_{SF} comprises the soot formation pressure, P_{T} comprises the tailstock end pressure, C₁ comprises a constant, T comprises a temperature, μ_{eff} comprises effective viscosity at temperature T (effective viscosity is the viscosity of the mixture of precursors), and x comprises the molar ratio of O₂ to a silicon containing precursor material. Preferably, the ratio comprises a molar ratio. An example of an initial deposition rate of glass comprises at least about 2.2 grams/minute. Preferably the pressure in the deposition zone (P_{D}) comprises

P_{D}=(P_{T}²(R_{I}²C₂mᵢt)+C₁Tμ_{efff}(1+x)mᵢ)^{1/2}/(R_{I}²−C₂mᵢt)

and the instantaneous deposition rate m can be determined by solving the following equation for m:

(P_{SF}²−P_{T}²)(R_{I}²−C₂mt)−C₁Tμ_{eff}(1=x)m=0

wherein C₂ comprises a constant and t comprises time. The temperature is determined in accordance with furnace 16. The tailstock pressure (P_{T}) can be measured by a pressure gauge within tailstock end 18, preferably tailstock end 18 includes a downstream manifold and a pressure gauge upstream of the vacuum pump. A typical value for P_{T} is about 10 Torr or less. The soot formation pressure is determined thermodynamically at temperature T. The soot formation pressure is determined from a phase diagram for the chemical compound of the glass forming material. The soot formation pressure is that pressure, for a given temperature, at which the phase of the glass forming material changes from a vapor to a liquid. An example of such a phase diagram is illustrated as FIG. 12. FIG. 12 is phase diagram for pure silica between pressures of 10 to 100 Torr. Preferably, the PCVD process is operated in the Vapor region of FIG. 12. A typical PSF comprises about 20 to about 15 Torr. The constant C₁ is a conversion factor and the constant C₂ comprises 1/(ππLρₛᵢₒ₂), wherein L comprises the length of substrate 20 and comprises the density of SiO₂ at temperature T.

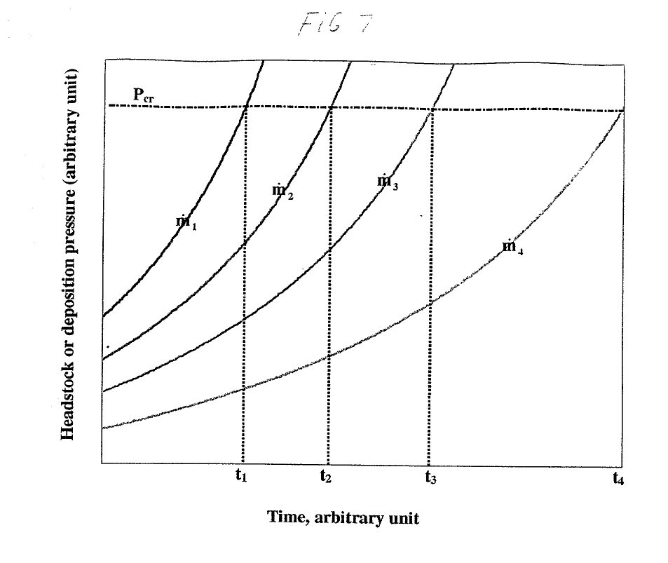

At least one embodiment of this method of the invention is graphically illustrated in FIGS. 7-9. FIG. 7 is a graph of the pressure in the deposition zone pressure, in arbitrary units, during deposition as a function of time for 4 mass flowrates. P_{SF} represents the soot formation pressure, a pressure at which the precursors react and form soot particles instead of glass. The mass flowrate of precursor material into substrate 20 is represented by m₁, m₂, m₃, and m₄. In this graph the relationship between the four mass flowrates comprises m₁>m₂>m₃,>m₄.

With respect to FIG. 7 and this method of the invention, the precursors are flown into the deposition zone at a mass flowrate of about m₁. Once the pressure in the deposition zone of substrate 20 reaches a predetermined point of no more than about 99% of the soot formation pressure, the mass flowrate of precursors into the deposition zone is changed to m₂. On FIG. 7, this change would occur at a predetermined point before time t₁. This process of changing the mass flow rate of the precursors is continued each time the pressure in the deposition zone reaches a predetermined point prior to P_{SF} with respect to m₂, m₃, and m₄. In an ideal situation, the pressure is maintained at the predetermined point below P_{SF} and the mass flowrate is changed an infinite amount of times.

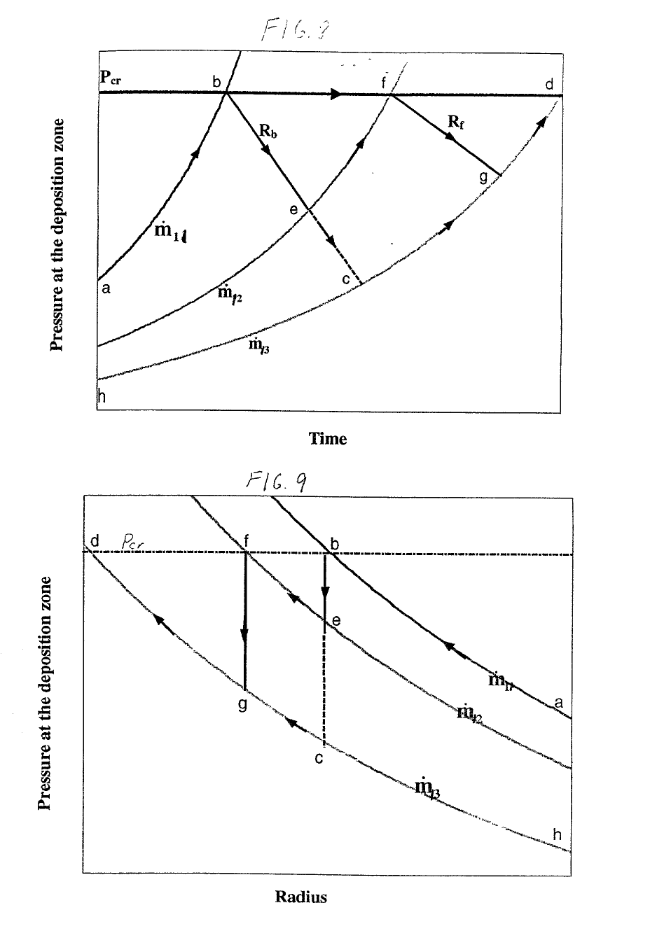

Another embodiment of this method of the invention is illustrated in FIGS. 8 and 9. FIG. 8 is a graph of the pressure in the deposition zone in terms of time with respect to three mass flowrates, m₁₁, m₁₂, and m₁₃. FIG. 8 illustrates two different modulations of the mass flowrate that may be used to practice the invention. A first modulation of the mass flowrate includes flowing precursor material into substrate 20 at a rate of m₁₁ from about point “a” to about point “b”, shown on FIG. 8. At about point “b”, preferably immediately before point “b” , the mass flowrate is changed to m₁₃ along the line between points “b” and “c” of FIG. 8. In this embodiment the flowrate of precursors into substrate 20 is continued until the pressure the deposition zone reaches point “d” on FIG. 8. In summary one embodiment of the method of the invention is represented on FIG. 8 as lines “ab”, “bc”, and “cd”.

In a second embodiment of the method of the invention, line “ab” is the same, except instead of modulating the flowrate to m₁₃, the flowrate is modulated to m₁₂. Thus, the second embodiment depicted includes line “be” instead of line “bc”. In the second embodiment, the flowrate of precursors into the deposition zone is continued until the pressure in the deposition zone reaches a predetermined point just before point “f”. At the predetermined point before point “f”, the flowrate is modulated to the flowrate m₁₃. The flowrate in the deposition zone is continued until the pressure the deposition zone reaches point d on FIG. 8. Thus, the second embodiment of the method of the invention depicted is illustrated by lines “ab”, “be”, “ef”, “fg”, and “gd”. As in the case with FIG. 7, the embodiment which maintains the pressure in the deposition zone as close as possible to P_{SF} is the more preferred embodiment.

In FIG. 9, the reduction in radius of substrate 20 is illustrated in terms of the pressure in the deposition zone for the two embodiments illustrated in FIG. 8. As illustrated in FIG. 9, the maximum reduction in radius is achieved by modulating the flowrates between m₁₁ and m₁₃. Likewise as in FIG. 8, the most efficient process illustrated in modulating the flowrate in manner such that precursors are flown into the deposition zone utilizing all three of the mass flowrates, m₁₁, m₁₂, and m₁₃, at different times during the deposition process.

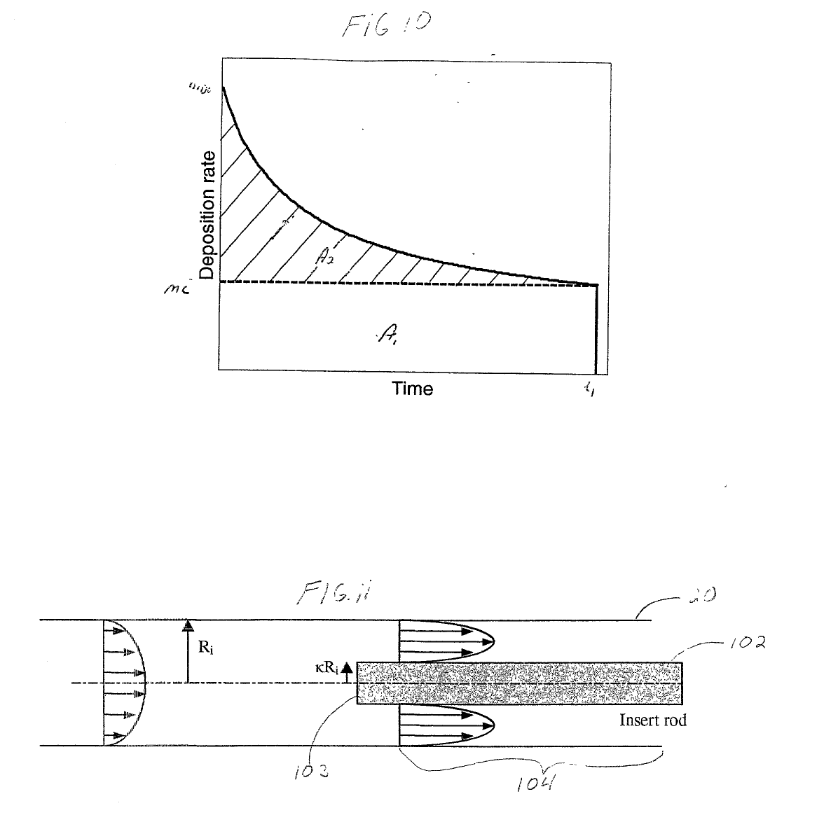

Depicted in FIG. 10 is the deposition rate of the glass onto substrate 20 as a function of time. The solid curve represents a PCVD process in which the deposition rate is continual modulated until the deposition rate reaches rate m_{c}. A constant deposition rate is also depicted in FIG. 10 by the dashed line at m_{c}. The amount of glass deposited during the deposition is equal to the area under the particular curve. For the dashed line, the amount glass deposited during the deposition process is equal to the area under the dashed line, represented by A₁ on FIG. 10. The amount of glass deposited during the inventive deposition is equal to the area under the solid line, represented by A₂ and A₁. Thus, it is clear from FIG. 10 that by practicing the invention the overall deposition rate is increased by the A₂ divided by t₁.

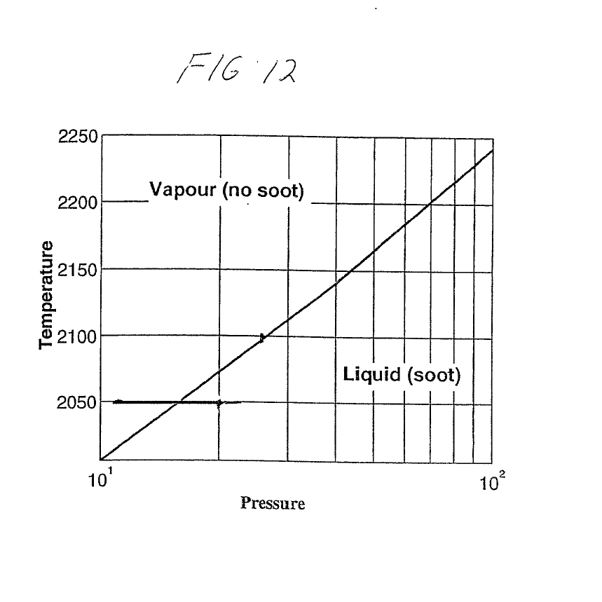

Any additional method that may be practiced to improve the efficiency of the deposition of glass is to reduce, preferably eliminate, the deposition of matter along a decay length portion 104 of substrate 20, see FIG. 11. The decay length is used herein to describe at least a portion of substrate 20 at which the thickness of the deposition of matter changes from the aforementioned uniform thickness associated with the “useable length” and decays to close to about 0. The method is a method of depositing glass on substrate 20. The method comprises the steps of (1) depositing glass on an internal surface of substrate 20, wherein substrate 20 has first and second ends; and (2) inserting a rod 102 inside the second end of the of substrate 20. Optionally, the length of the segment of rod 102 that extends into substrate 20 is less than the entire length of substrate 20. Preferably the length of the segment of the rod 102 comprises less than about 50% of the length of substrate 20. More preferably the length of the segment comprises less than about 25% of the length of substrate 20. It is further preferred that the length of the segment comprises less than the length of applicator 14, more preferably less than 50% of the length of applicator 14.

Preferably, rod 102 is concentrically aligned with an internal surface of substrate 20, as illustrated in FIG. 11. It is also preferred that an external diameter of rod 102 comprises at least 25% of an internal diameter of substrate 20. It is further preferred that the external diameter of rod 102 comprises no more than about 75% of said internal diameter of substrate 20. Preferably, the second end of substrate 20 is adjacent the tailstock end 18 of apparatus 10.

Preferably a first end 103 of rod 102 inserted into substrate 20 is a turnaround point of applicator 14 during the deposition process. Once a front end of applicator 14 and end 103 form a vertical line, applicator 14 traverses back towards headstock end 12 of apparatus 10.

Preferably, decay length of material deposited along the internal surface of substrate 20 comprises L₁ wherein:

L₁=L₀((1−k)/(1+k)).

L₀ comprises the decay length in substrate 20 without rod 102 inserted in substrate 20 and “κ” comprises a constant regarding the difference in an external diameter of rod 102 and an internal diameter of substrate 20. The constant “Kκ comprises the external diameter of rod 102 divided by the internal diameter of substrate 20. Lₒ comprises about Uₒ(Rᵢ²/D), wherein Uₒ comprises the average gas velocity of matter into substrate 20, Rᵢ comprises the inner radius of substrate 20, and D comprises the diffusivity of the depositing matter. The variable L₀ may also be determined experimental.

Advantages, which will result from practicing the aforementioned method, include creating a short deposition zone. A short deposition zone has the advantage of limiting, preferably eliminating, the deposition of matter along decay length portion 104 of substrate 20. Matter is used in this method of the invention to mean at least soot particles, glass and combination thereof. Matter deposited along decay length portion 104 results in the inefficient use of precursors and the deposition of soot particles instead of glass. In turn the deposition of soot particles will cause abatement issues with the vacuum pump enclosed in tailstock end 18. Therefore, there are several benefits to not depositing matter along decay portion 104 of substrate 20.

It will be apparent to those skilled in the art that various modifications and variations can be made to the present invention without departing from the spirit and scope of the invention. Thus, it is intended that the present invention covers the modifications and variations of this invention provided they come within the scope of the appended claims and their equivalents.

What is claimed is:

1. A method of making an optical fiber preform assembly comprising:
forming a plasma inside a tube, thereby forming a plasma zone; and
introducing a flow of at least one precursor suitable for forming glass into the plasma zone, wherein said flow comprises eddy diffusion of the flow of the precursor.

2. A method of making an optical fiber preform assembly comprising:
forming a plasma zone inside a tube, thereby forming a plasma zone;
introducing a flow of at least one precursor suitable for forming glass into the plasma zone; and
creating eddy diffusion flow in the plasma zone.

3. The method according to claim 2 wherein said creating eddy diffusion comprises inserting an eddy element inside said tube.

4. The method according to claim 3 further comprising aligning said element along an axial centerline of said tube, thereby preventing said precursor from flowing along a center axis of the tube from a first end of the tube to a second end of the tube.

5. The method according to claim 3 wherein a length of said eddy element comprises substantially the same length as the useable length of said tube.

6. The method according to claim 2 wherein said creating eddy diffusion comprises pulsing an energy source to form said plasma.

7. The method according to claim 6 wherein said energy source comprises a microwave energy source.

8. The method according to claim 2 wherein said creating comprises imparting a spiral spin into the plasma.

9. The method according to claim 2 further comprising depositing glass on an inner surface of said tube at a rate of greater than about 1.5 grams/minute.

10. The method according to claim 9 wherein said deposition rate comprises at least about 2.5 grams/per minute.

11. The method according to claim 9 wherein said depositing comprises depositing matter substantially free of soot particles.

12. The method according to claim 9 further comprising ceasing said depositing prior to an inner radius of said tube being less than about 10% of an inner radius of said tube prior to said depositing.

13. The method according to claim 2 wherein said creating comprises forming a gradient in the concentration in the plasma zone in the axial direction of said tube.

14. The method according to claim 2 further comprising churning said precursor.

15. A microwave applicator for forming a plasma for a chemical vapor deposition process comprising:
a housing and a surface adjacent an outer surface of a substrate, wherein said surface comprises at least one portion protruding toward said outer surface of the substrate.

16. The microwave applicator according to claim 15 wherein said portion comprises at least one helical rib that extends along at least a segment of said surface of the applicator.

17. The microwave applicator according to claim 15 wherein said segment comprises at least a majority of said surface.

18. The microwave applicator according to claim 15 wherein said portion comprises a plurality of baffles staggered along at least a segment of said surface.

19. The microwave applicator according to claim 15 wherein said portion comprises a plurality of baffles aligned along at least a segment of said surface.

20. The microwave applicator according to claim 15 wherein said portion comprises a conductive heating element.

21. The microwave applicator according to claim 15 wherein said portion comprises an element capable of forming a thermal gradient along the outer surface of the substrate.

22. The microwave applicator according to claim 15 wherein said portion can be physically oscillated within the applicator.

23. A method of depositing glass on a substrate comprising:
flowing at least one glass precursor material at a predetermined mass flow rate into a substrate, wherein the predetermined mass flow rate comprises a rate at which the pressure within the substrate comprises no more than about 99% of the soot formation pressure;
reacting the glass precursor inside the substrate; and
subsequently modulating the mass flow rate to maintain the pressure within the substrate substantially constant.

24. The method according to claim 23 wherein the pressure within the substrate comprises no more than about 95% of the soot formation pressure.

25. The method according to claim 23 wherein the pressure within the substrate comprises no more than about 90% of the soot formation pressure.

26. The method according to claim 23 wherein the pressure within the substrate comprises no more than about 85% of the soot formation pressure.

27. The method according to claim 23 wherein said modulating comprises reducing the mass flow rate of said glass precursor material.

28. The method according to claim 23 wherein said glass precursor material comprises a silicon containing compound.

29. The method according to claim 23 wherein said reacting comprises forming a plasma inside said substrate.

30. The method according to claim 29 further comprising maintaining an intensity of said plasma substantially constant during said reacting.

31. The method according to claim 23 wherein said modulating comprises a stepwise modulation of said mass flow rate.

32. The method according to claim 23 wherein said modulating comprises a continuous modulation of said mass flow rate.

33. The method according to claim 23 further comprising depositing glass on an inner surface of said substrate, wherein an initial deposition rate of glass comprises at least about 2.2 grams/minute.

34. The method according to claim 33 wherein an initial deposition rate during said depositing comprises
mᵢ=R_{I}⁴ (P_{SF}²−P_{T}²)/(C₁Tμ_{eff}(1+x))
wherein mᵢ comprises an initial deposition rate, R_{I} comprises initial internal radius of the substrate, P_{SF} comprises the soot formation pressure, P_{T} comprises the tailstock end pressure, C₁ comprises a constant, T comprises temperature, μ_{eff} comprises effective viscosity at temperature T, and x comprises the ratio of O₂ to a silicon containing precursor material.

35. The method according to claim 34 wherein a pressure in the deposition zone (P_{D}) comprises
P_{D}=(P_{T}²(R_{I}²−C₂mᵢt)²+C₁Tμ_{eff}(1+x)mᵢ)^{1/2}/(R_{I}²−C₂m₁t)
wherein C₂ comprises a constant and t comprises time.

36. The method according to claim 34 wherein an instantaneous deposition rate comprises (P_{SF}²−P_{T}²)(R_{I}²−C₂mt)−C₁Tμ_{eff}(1=x)m=0, wherein C₂ comprises a constant and t comprises time.

37. A method of depositing glass on a substrate comprising:
depositing glass on an internal surface of a substrate having first and second ends; and
inserting a rod inside said second end of the of the substrate, wherein a length of said rod inside said substrate comprises less than the length of said substrate.

38. The method according to claim 37 wherein an external diameter of said rod comprises at least 25% of an internal diameter of said substrate.

39. The method according to claim 38 wherein said external diameter of said rod comprises no more than about 75% of said internal diameter of said substrate.

40. The method according to claim 37 wherein a decay length of material deposited along the internal surface of said substrate comprises L₁ wherein
L₁=L₀((1−k)/(1+k))
L₀ comprises the decay length in the substrate tube without the rod inserted in the tube and kcomprises a constant regarding the difference in an external diameter of the rod and an internal diameter of the substrate.

41. The method according to claim 37 further comprising aligning an external diameter of the rod substantially concentrically to an internal diameter of the substrate.

42. The method according to claim 37 wherein a said length of said rod comprises less than about 50% of said length of said substrate.

43. A method of making an optical fiber preform assembly comprising:
inserting an eddy current element into a substrate;
forming a plasma zone inside a tube, thereby forming a plasma zone; and
introducing a flow of at least one precursor suitable for forming glass into the plasma zone.
